(19) United States
(12) Patent Application Publication
(10) Pub. No.: US 2006/0276076 A1
(43) Pub. Date: Dec. 7, 2006

(54) Customizable power cord

(75) Inventor: Candido Alvarado, Houston, TX (US)

Correspondence Address: SCHUBERT OSTERRIEDER & NICKELSON PLLC, 6013 CANNON MTN DR, S14, AUSTIN, TX, 78749, US

(73) Assignee: CANDIDO ALVARADO and CAROL ALVARADO

(21) Appl. No.: 11/144,922

(22) Filed: Jun. 3, 2005

(51) Int. Cl. H01R 11/00

(52) U.S. Cl. 439/502

(57) ABSTRACT

Devices and kits are disclosed for customizable power cords. In one example embodiment, a device for a customizable power cord generally includes a single cord insulating a wire having a capacity to carry an electrical current, wherein the single cord has a predetermined length. The device further includes a plurality of pass-through plug outlets configurably affixed to the single cord along the predetermined length, and, thereby, in electrical contact with the wire. Further still, the device includes a terminal at a first end of the predetermined length, and a terminal plug outlet, wherein the terminal plug outlet is affixed to a second end of the predetermined length, and, thereby, in electrical contact with the wire. In a further example embodiment, the device includes one or more electrically activated devices, wherein each one is in electrical connection with one of the plurality of the pass-through plug outlets.

### FIELD OF INVENTION

The invention generally relates to devices and kits for customizing a power cord used in interior or exterior environments, and, in particular, for mounting to a surface, such as to the eves of a house or to a building, for repeated, similar uses over for extended periods of time.

### BACKGROUND

Electrical power cords are commonplace in home and commercial environments. Normally, power cords normally include two or three wires within a insulating jacket, such as a cord, and the wires are connected at one terminus to a male plug outlet and at the other terminus to a female plug outlet.

Oftentimes, whether in residential or commercial environments, commercially available power cords are strung together to span a user's desired distance for various applications, such as, from which hanging holiday ornamentations require electricity for these ornamentations' actuation or illumination. Not only does stringing multiple power cords cause a known fire hazard, but, there is a finite number of electrical connections. Specifically, in the above-referenced normal power cord, there is only one electrical connection point, which occurs at each juncture of two connecting power cords. As a result, multiple power cords are required for applications that require multiple electrical connection points. As easily envisaged, a massive wrangling of strung-together power cords, otherwise functionally needed for the multiple electrical connection points, is aesthetically unpleasing for display when the point of the display is aesthetics, e.g., hanging Christmas wreathes that illuminate. In addition, use of multiple power cords is a cost inefficient manner in which to achieve multiple points of electrical connectivity; in fact, it is overkill. These problems are exacerbated by the often limited power supply availability to which multiple power cords, when the power cords are necessary to separate in order to span and achieve the otherwise desired multiple points of electrical connectivity for the desired application. And, finally, these problems are especially irksome to a user who repeatedly encounters these problems for the same or similar need for multiple electrical connectivity points via power cords for the same or various applications occurring over periodic intervals.

Accordingly, in light of the example, above-identified problems, a need, therefore, exists for devices and kits for a customizable, and optionally mountable, power cord having multiple, configurable points of electrical connectivity for cost-efficient, safe applications that would otherwise require stringing together multiple strands of aesthetically unpleasing, commercially available power cords.

### SUMMARY OF THE INVENTION

In one example embodiment, a device for a customizable power cord generally includes a single cord insulating a wire having a capacity to carry an electrical current, wherein the single cord has a predetermined length. The device further includes a plurality of pass-through plug outlets configurably affixed to the single cord along the predetermined length, and, thereby, in electrical contact with the wire. Further still, the device includes a terminal at a first end of the predetermined length, and a terminal plug outlet, wherein the terminal plug outlet is affixed to a second end of the predetermined length, and, thereby, in electrical contact with the wire. In a further example embodiment, the device includes one or more electrically activated devices, wherein each one is in electrical connection with one of the plurality of the pass-through plug outlets. An example of such electrically activated devices includes lighted Christmas wreaths.

Another example embodiment is a kit for assembling a customizable power cord. The kit generally includes a single cord insulating a wire having a capacity to carry an electrical current, wherein the single cord has a customizable length. The kit further includes a plurality of pass-through plug outlets to configurably affix to the single cord and the wire along the customizable length, whereby the plurality are in electrical contact with the wire. Further still, the kit includes a terminal at a first end of the customizable length, and a terminal plug outlet, wherein the terminal plug outlet is affixed to the second end of the customizable length and the wire, whereby the terminal plug outlet is in electrical contact with the wire. In a further example embodiment, the kit includes accessories for inclusion into the customizable power cord. Examples of such accessories include a timer and one or more switches to control the overall or specific electrical operability of plug outlets in the device.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an example customizable power cord device in accordance with the disclosed invention.

FIG. 2 depicts an example customizable power cord device in accordance with the disclosed invention.

FIG. 3 depicts an example cross-section of a pass-through plug output in accordance with the disclosed invention.

FIG. 4 depicts component parts for inclusion in an example kit for use in assembling a customizable power cord in accordance with the disclosed invention.

### DETAILED DESCRIPTION OF EXAMPLE EMBODIMENTS

The following is a detailed description of example embodiments of the invention depicted with assistance and reference to the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

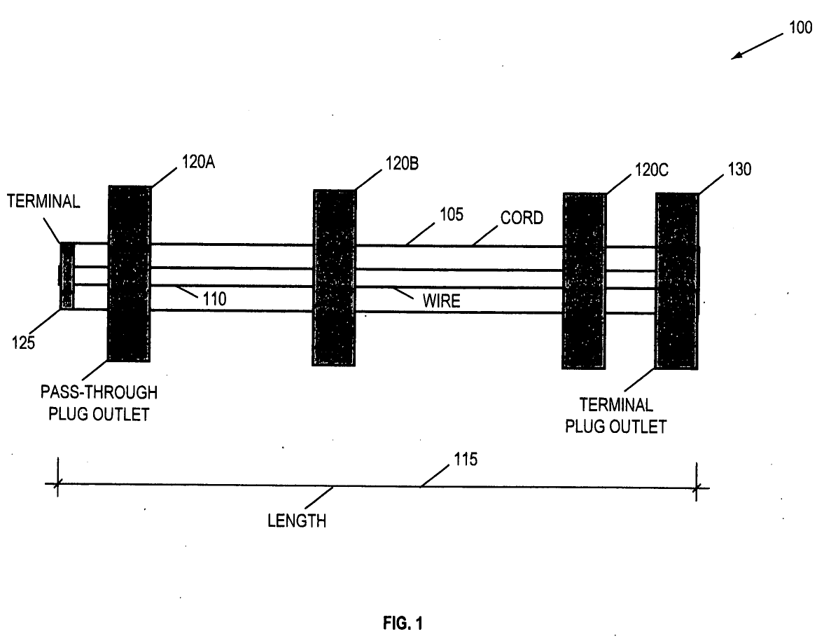

Generally speaking, devices and kits for a customizable power cord are contemplated. Referring to FIG. 1, an example customizable power cord device 100 is presented. The device 100 includes a single cord 105 insulating an electrically conductive material, such as a wire 110, wherein the corded 105 wire 110 has a specific length 115. The corded 105 wire 110, for example, may be Carol Mfg. No. 02301 18/2 flexible cord rated at 300 v in white or brown supplied in 250 foot bulk roll. As discussed in later embodiments, the length 115 is customizable to the user's desired application. For example, a user may desire to customize the length 115 of the corded 105 wire 100 to span the periphery of a residence, wherein the configurably placed pass-through plug outlets 120A, 120B are affixed, such as by clamping and optionally glued into position with an adhesive substance, such as silicone, at different intervals along the corded 105 wire 110. By clamping into position, the pass-through plug outlets 120A, 120B form an electrical contact with the wire 110 in the cord 105 by the clamping actually piercing the pass-through plug outlets 120A, 120B, such as Eagle Electrical Mfg. Cat. No. Bp 2606 W or B. As a result, the user's configurably placed pass-through plug outlets 120A, 120B provide electrical connectors to various electrically activated devices, such as ornamental lighted wreaths serving as Christmas decorations, at places along the residence where the user desires to display such electrically activated devices.

FIG. 1 further depicts a terminal 125 and a terminal plug outlet 130, which appear at opposite ends of corded 105 wire 110 and serve to safely and necessarily close the circuit. The terminal plug outlet 130 is similar to the pass-through plug outlets 120A, 120B in functionality, but differs in that the terminal plug outlet 130 is the last type of plug outlet before a terminal end of the corded 105 wire 110. In addition, the terminal plug outlet 130, such as Eagle Electrical Mfg. Cat. No. Bp 2607 W or B, may be adapted to connect to an enabling power supply, such a battery, solar, or, in general, an AC or DC power source. The terminal 125 at the other end of the corded 105 wire 110, in alternative example embodiments, may be a cap, electrical tape, another terminal plug outlet, or sealed or sealable end.

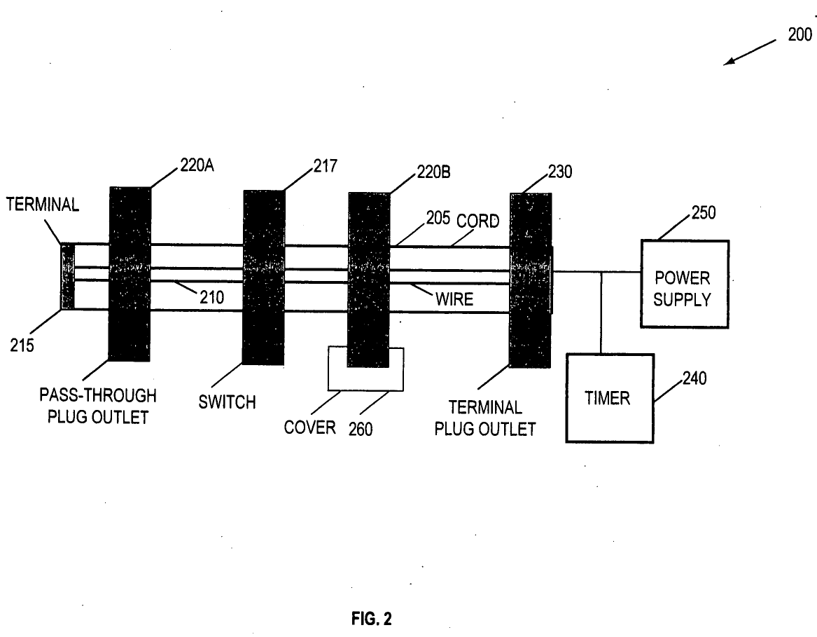

Turning now to FIG. 2, again, further discussion of an example customizable power cord device 200 is presented, which is also relevant to the previous discussion of device 100 in FIG. 1. In fact, some of the matter discussed in FIG. 1 appears in FIG. 2, and FIG. 2 is presented to assist in understanding FIG. 1, and to further elucidate on the details of the disclosed invention.

Again, FIG. 2 depicts a cord 205 insulating an electrically conductive wire 210 for a customizable power cord device 200. The above-discussed power supply 250 is depicted in electrical connection with a terminal plug outlet 230, which appears at one terminal of the corded 205 wire 210. The electrical contact of the power supply 250 to the terminal plug outlet 230 may be through a direct contact via electrical connectors, such as male prongs on the terminal plug outlet 230 inserted into a female receptacle on the power supply 250. An example of such would be interior or exterior, male pronged terminal plug outlet 230 inserting into a conventional electrical power supply outlet located on a business or residential building's surface, such as wall. As an alternative to direct contact of the terminal plug outlet 230 to a power supply 250, a user may use commercially available electrical connectivity wire to connect the power supply 250, such as a battery, to the terminal plug outlet 230, whereby the electrical connectivity wire bridges the gap between the terminal plug outlet 230 to a power supply 250, and allows electricity to flow through the now closed circuit depicted in FIG. 2.

FIG. 2 also depicts additional articles, namely a switch 217, cover 260, and timer 240, for optional inclusion in alternative embodiments of the device 200. The switch 220, whether one or many are included in alternative embodiments of the device 200, controls electrical operability of one or more pass-through plug outlets 220A, 220B. Depending on the configurable positioning of a switch 217 along the corded 205 wire 210, a switch 217 will turn off or on, or adjust, such as through a dialable rheostat controlled switch 217, the electricity reaching the particular pass-through plug outlets; here, in FIG. 2, the switch 217 controls pass-through plug outlet 220A at the far end from the power supply 250, a position determined relative to the switch 217 location between two plug outlets. In an alternative, non-depicted embodiment, a switch 217 could instead be positioned between pass-through plug outlet 220B and terminal plug outlet 230. In this latter, non-depicted, alternative embodiment, such a switch 217 would control the electrical operability of both pass-through plug outlets 220A and 220B. More examples are possible, including the inclusion of a plurality of switches 220 along the corded 205 wire 210, whereby the electrical operability of the affected plug outlets would depend on the various permutations of the settings and placement of these plurality of switches 220.

A timer 240, optionally including a switch like switch 217, is depicted for optional inclusion into the device 200, wherein the timer 240 is depicted as being connected via electrical connectivity wire to the corded 205 wire 210. A timer 240, such as Intermatic Cat. No. HB31R, would be especially beneficial for a device 200 mounted to an interior or exterior surface when a user desires electrically activated devices, such as actuating figures, connected to the one or more of the plug outlets 220A, 220B, 230 to actuate the figures at fixed intervals on a fixed basis, e.g., from 7:30 a.m. to 9:30 a.m. each day. In regards to mounting the device 200, horseshoe-shaped nails, as opposed to conventional staples or nails, are better for attaching the device 200 to a surface because the latter tend to tear into the cord 205, and, thereby, especially for long-term mountings of the device 200, expose the wire 210, which leads to short-outs and inoperability; this is especially true for devices 200 used in the exterior and mounted on a surface year round. As a specific example, 11 mm round crown monel staples may be used to attach the device 200 to a surface, such as floor or wall, through use of an Arrow Model No. T2025 stapler. Such corrosion-resistant staples do not pierce the device 200 upon mounting.

In addition to the device 200 being paintable or existing in a pre-determined color, such as brown or white, the device 200 depicted in FIG. 2 shows a cover 260 connected to pass-through plug outlet 220B. The cover 260, whether for a particular pass-through plug outlet 220B as depicted, or used on all of the plug outlets in the device 200, serve to removably seal and protect the male and female electrical connectors on the plug outlets, and, thereby, avoid short-outs or other damage to the electrical components of the corded 205 wire 210, as well as protecting the user and the public encountering these devices 200 from undesirable electrical contact with the device 200. The cover 260, itself, may be permanently attached to a plug outlet, such as through a loop attached to the plug outlet. In an alternative embodiment, the cover 260 may not be permanently attached to one or more plug outlets, and simply, removably added to the plug outlets when desired.

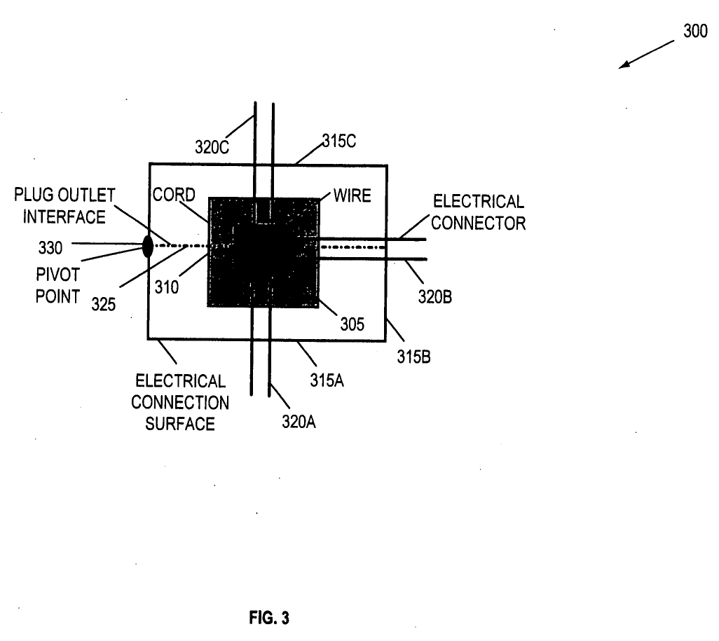

Now, moving to FIG. 3, an example cross-section of a plug outlet 300 is depicted. The plug-outlet 300 includes one or more electrical connection surfaces 315A, 315B, 315C. As depicted, the plug-outlet 300 has three electrical connection surfaces 315A, 315B, 315C because each of these surfaces 320A, 320B, 320C have an associated electrical connector 320A, 320B, 320C. In this particular embodiment, it is noted that all three electrical connectors 320A, 320B, 320C are of a male type, but, in alternative embodiments, they may all be female or a combination of male and female. In addition, the plug-outlets 300 may be interior, exterior or a combination of interior and exterior plug-outlets 300 depending on the user's environmental placement of the mountable or non-mountable customizable device, such as the device 100 or 200 depicted in FIGS. 1 and 2, respectively.

The cross section of the plug-outlet 300 also shows the cord 310 insulating the wire 305. Notably, the corded 310 wire 305 is depicted as quadrilateral in shape, but it is understood that the shape of the corded 310 wire 305 is illustrative only; that is, the shape of the corded 310 wire 305 may be any shape that permits the invention to work for its intended purpose.

With final reference to FIG. 3, a plug-outlet interface 325 is depicted for example edification on assembly of a customizable device, such as the device 100 or 200 respectively depicted in FIGS. 1 and 2. The interface 325 is the meeting of two interior faces of a plug-outlet 300 after the plug-outlet 300 has been affixed, such as through clamping and with or without the assistance of an adhesive substance, to the corded 310 wire 305 in order to establish electrical connectivity of the plug-outlet 300. Prior to clamping, the plug-outlet 300 pivots about the pivoting point 330, whereby the plug-outlet 300 has two, symmetrical interior faces that form a cavity upon clamping together the plug-outlet. The plug-outlet's 300 cavity is the space in which the corded 310 wire 305 securely and tightly sets after clamping together the plug-outlet 300. To ensure a secure and tight connection, as well as permanency, an adhesive material is applied to one or both of the plug-outlet's interior, symmetrical, and opposing surfaces. In this manner, the adhesive substance, such as a durable glue or silicone, ensures an impermeable seal about the plug outlet interface 325.

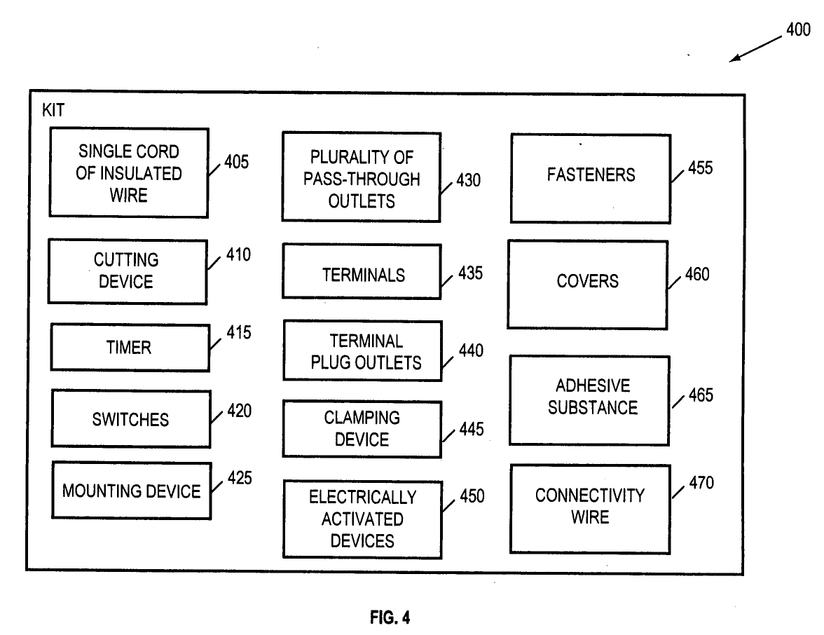

Now, turning to FIG. 4, another aspect of the invention is depicted. In particular, example and optional components for inclusion into a kit 400 for assembling a customizable power cord is depicted. Together, these components, as previously described, may be used to form a customizable power cord based on the user's wishes and intended application.

The kit 400 includes a variable length of a single cord of insulated wire 405 capable of carrying an electrical current. For large applications, an example variable length would be hundreds of feet, but in smaller kits 400, the length may be only 50 feet. The chosen length is entirely variable, and commercial supply and demand would likely be considered in determining the exact length of the single cord of insulated wire 405 for inclusion in a kit 400.

Additional components for including in an example kit 400 include a cutting device 410, such as scissors or wire snips, and fasteners 455, such as appropriate and enabling tacks, ties, and horseshoe-shaped nails so as not to penetrable the interior of the single cord of insulated wire 405. These fasteners 455 secure the customizable power cord, such as device 100 and 200 in FIGS. 1 and 2, respectively, into place on a chosen surface with a mounting device 425, such as a hammer or staple gun. As previously discussed, the kit 400 may include a timer 415, a plurality of various types of switches 420, and a plurality of pass-through outlets 430 and terminal plug outlets 440 (collectively, “plug outlets”). Again, these plurality of plug outlets 430, 440 may vary in the number of sides that have electrical connectors, and these electrical connectors may be for interior, exterior, or a combination of exterior and interior uses, as well as being male, female, or a combination of male and female.

The example kit 400 may also include various terminals 435, such as electrical tape, caps, sealant devices, or additional terminal plug outlets, as well as covers 460 to safely seal the exposed electrical connectors of the plug outlets from the environment and unintended user interaction. To assist in customizable placement of the various kit 400 components, the kit 400 may also include a clamping device 445, and an adhesive substance 465 to seal and make permanent connections during assembly, wherein an example of such is the clamping together of opposing, symmetrical interior faces of a plug outlet to the single cord of insulated wire 405. Finally, the kit 400 may also include a variable length of connectivity wire 470 to assist the user in connecting and forming electrical communication for devices, such as a timer 415 to the single cord of insulated wire 405, if such timer 415 is not clampable to the single cord of insulated wire 405 in a example manner such as the example, clampable, above-described plug outlets.

While the foregoing is directed to example embodiments of the disclosed invention, other and further embodiments of the invention may be devised without departing from the basic scope thereof, and the scope thereof is determined by the claims that follow.

What is claimed is:

1. A device, comprising:
a single cord insulating a wire having a capacity to carry an electrical current, wherein the single cord has a predetermined length;
a plurality of pass-through plug outlets configurably affixed to the single cord along the predetermined length, and, thereby, in electrical contact with the wire;
a terminal at a first end of the predetermined length; and
a terminal plug outlet, wherein the terminal plug outlet is affixed to a second end of the predetermined length, and, thereby, in electrical contact with the wire.

2. The device of claim 1, further comprising one or more electrically activated devices, wherein each one is in electrical connection with one of the plurality of the pass-through plug outlets.

3. The device of claim 2, wherein the electrically activated devices comprise one or more devices having a capacity to actuate.

4. The device of claim 2, wherein the electrically activated devices comprise one or more lighted devices.

5. The device of claim 1, further comprising a timer in electrical communication with the wire and substantially located at the second end of the predetermined length.

6. The device of claim 1, further comprising one or more switches in electrical communication with the wire, and having one or more locations selected from the group consisting of between pass-through plug outlets, between one of the plug outlets and the terminal plug outlet, and between the terminal plug outlet and a power supply, whereby the one or more switches control the electrical operability of the plug outlets.

7. The device of claim 1, wherein an adhesive substance in located between opposing interior faces of the plug outlets for securing the plug outlets into a configured place along the single cord.

8. The device of claim 1, wherein the plurality of pass-through plug outlets and the terminal plug outlet comprise plug outlets having one or more electrical connectors selected from the group consisting of male, female, and a combination of male and female.

9. The device of claim 1, wherein the plurality of pass-through plug outlets and the terminal plug outlets comprise plug outlets selected from the group consisting of interior, exterior, and a combination of interior and exterior.

10. The device of claim 1, wherein the plurality of pass-through plug outlets and the terminal plug outlets comprise removable covers.

11. The device of claim 1, wherein the terminal plug outlet is adapted to connect to a power supply.

12. The device of claim 1, wherein the device is mounted to a surface for a period of time.

13. The device of claim 1, wherein the device is paintable.

14. The device of claim 1, wherein the device has a predetermined color.

15. The device of claim 1, wherein the terminal comprises another terminal plug outlet.

16. The device of claim 1, wherein the terminal comprises a capped end.

17. The device of claim 1, wherein the terminal comprises a sealed end.

18. The device of claim 1, wherein each the plurality comprises one or more electrical connection surfaces.

19. A kit for assembling a customizable power cord, the kit comprising:
a single cord insulating a wire having a capacity to carry an electrical current, wherein the single cord has a customizable length;
a plurality of pass-through plug outlets to configurably affix to the single cord and the wire along the customizable length, whereby the plurality are in electrical contact with the wire;
a terminal at a first end of the customizable length; and
a terminal plug outlet, wherein the terminal plug outlet is affixed to the second end of the customizable length and the wire, whereby the terminal plug outlet is in electrical contact with the wire.

20. The kit of claim 19, further comprising a cutting device to cut the single cord to generate the customizable length.

21. The kit of claim 19, further comprising a timer to affix to the single cord and the wire, whereby the timer is in electrical contract with the wire.

22. The kit of claim 19, further comprising one or more switches to affix to the single cord and the wire so as to form an electrical connection to the wire, whereby the one or more switches control the electrical operability of one or more of the plug outlets.

23. The kit of claim 19, further comprising a plurality of removable covers for covering the plurality of pass-through plug outlets and the terminal plug outlets.

24. The kit of claim 19, further comprising fasteners for mounting the customizable power cord to a surface for a period of time.

25. The kit of claim 19, further comprising an adhesive substance for securing affixation of the plurality and the terminal plug outlets to the single cord.

26. The kit of claim 19, further comprising one or more electrically activated devices, wherein each one is in electrical connection with one of the plurality of the pass-through plug outlets.

27. The kit of claim 19, further comprising a clamping device for securing the plurality of pass-through plug outlets and terminal plug outlets into place on the cord.

28. The kit of claim 19, further comprising a mounting device for securing the plurality of pass-through plug outlets and terminal plug outlets into place along a surface.

29. The kits of claim 19, further comprising connectivity wire for making electrical connections between a device and at least the wire in the cord.

30. The kit of claim 19, wherein the plurality of pass-through plug outlets and the terminal plug outlet comprise plug outlets having one or more electrical connectors selected from the group consisting of male, female, and a combination of male and female.

31. The kit of claim 19, wherein the plurality of pass-through plug outlets and the terminal plug outlets comprise plug outlets selected from the group consisting of interior, exterior, and a combination of interior and exterior.

32. The kit of claim 19, wherein the terminal comprises another terminal plug outlet.

33. The kit of claim 19, wherein the terminal comprises a cap.

34. The kit of claim 19, wherein the terminal comprises a means for sealing the terminal.

35. The kit of claim 19, wherein the customizable length of the single cord is at least fifty feet.

36. The kit of claim 19, wherein each of the plurality comprise one or more electrical connection surfaces.
